(19) United States
(12) Patent Application Publication
(10) Pub. No.: US 2007/0008710 A1
(43) Pub. Date: Jan. 11, 2007

(54) Emergency and low-lighting system

(76) Inventors: Lyman O. Nielson, Fruit Heights, UT (US); Norman B. Hess, Fruit Heights, UT (US)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/455,604

(22) Filed: Jun. 19, 2006

Related U.S. Application Data
(60) Provisional application No. 60/692,117, filed on Jun. 20, 2005.

(51) Int. Cl. F21V 19/04

(52) U.S. Cl. 362/20

(57) ABSTRACT

A new lighting system is disclosed that may be used as an emergency lighting system, a night lighting system, and as a security lighting system. The lighting system includes a plurality of lights that are installed in a building. These lights are attached to low-voltages wires. In turn, the wires are attached to a control unit which includes timers and a controller. The controller is designed such that it may turn individual lights on and off at specified times during the day. Likewise, the system in constructed such that in the event of a power outage or other emergency, lights in the system will turn on and indicating to the building occupants where the building exits are located.

### CROSS-REFERENCED RELATED APPLICATION

This application claims the benefit of U.S. Provisional Application No. 60/692,117, filed Jun. 20, 2005. This application also claims priority to U.S. patent application Ser. No. 11/435,945 (filed May 17, 2006), which is a continuation-in-part of U.S. patent application Ser. No. 10/733,853, filed Dec. 11, 2003, which claims the benefit of U.S. Provisional Patent Application Ser. No. 60/432,562, filed Dec. 11, 2002. All of these prior applications are expressly incorporated herein by reference.

### BACKGROUND OF THE INVENTION

1. The Field of the Invention

The present invention relates to systems for lighting an area. More specifically, the present invention relates to a lighting system that may be used to provide emergency lighting, security lighting, low-level night lighting, or other lighting needs.

2. The Relevant Technology

For about one hundred years, electric lights and lighting systems have been routinely used in buildings and residences. In fact, building safety codes now mandate that lights and lighting systems be part of the building. Thus, any commercial or residential building presently used in the United States should have some type of lights or lighting systems.

As lighting systems have progressed, other types of lighting systems have also been developed to address specific lighting needs. For example, “emergency” (or “egress”) lighting systems have been developed to increase the safety of buildings. These systems usually include incandescent or halogen lights that are powered by battery backup systems. Specifically, these systems are designed such that these lights will turn on in the event that there is a power outage or other type of emergency. If an emergency or power outage occurs, the emergency lights of these systems illuminate the building and indicate to the building-occupants where the exits are located. Hopefully, by following the indications provided by the emergency lights, the occupants will then be able to efficiently and safely find the appropriate hallways, stairways, etc. that will lead them out of the otherwise dark building. Such emergency lights have the further advantage in that they may also provide light so that rescue personnel (such as firefighters, etc.) can enter and navigate through the building quickly and efficiently.

Most people believe that the inclusion of such emergency lighting system will increase the overall safety of the building. Thus, most building safety codes mandate that all commercial buildings (including office buildings, theaters, stores, etc.) have emergency lighting systems. Emergency lights, however, are not presently required for most residential buildings.

However, given their added safety advantages, many homeowners have voluntarily chosen to install such lighting systems in their homes as a way of providing additional security for their families. Generally, these type of residential emergency lighting systems are either (1) portions of smoke alarm systems or (2) external devices that are positioned along the floor and may be plugged in to an electrical outlet.

In addition to emergency lighting systems, many homeowners have also desired additional lighting systems to function as night lighting systems (which are sometimes called “nightlights”). These lights are generally plugged into an electrical outlet and are designed such that during the night (or in other periods of darkness), these lights will provide low-level lighting to an area. Although the amount of light provided by these nightlights is generally small, these nightlights do provide sufficient light so that a person can walk in the area without colliding with the furniture, walls, etc. Parents of small children often purchase such nightlights if their child is “afraid of the dark” or as a way of preventing injury to their child if the child gets up in the night (such as to go the bathroom, to get a drink of water, etc.).

Finally, owners of both commercial and residential buildings have begun using lighting systems as part of the buildings' security system. Generally, these lighting systems (which are sometimes called security lighting systems) are programmed so that multiple lights, in different parts of the house or building, will switch on and off at different times of the day. Usually, these security systems will use a timer that is attached to one or more floor lamps such that these lamps will turn on and off at desired times of the day. Hopefully, by turning these lights on and off at selected times, a would-be perpetrator will believe that someone is actually present in the building and will be deterred from trying to vandalize/rob the building.

While the above-described lighting systems are generally effective in accomplishing their purpose, such systems are often difficult to install and/or expensive to install and operate. Moreover, most present systems do not have any way to combine emergency lighting systems with security lighting systems and/or night lighting systems. Accordingly, there is a need in the art for a new type of lighting system that is inexpensive to use and operate. Likewise, there is a need in the art for a lighting system that may be used as an emergency lighting system, a night lighting system, and as a security lighting system. Such a device and system is disclosed herein.

### BRIEF SUMMARY OF THE INVENTION

This invention provides a new type of lighting system that may be readily used as a night lighting system, an emergency lighting system, and as a security lighting system. The system generally comprises a series of light emitting diodes (“LEDS”) that are electrically connected to a control unit via low-voltage wires. In some embodiments, the LEDs will provide low-level lighting, although more powerful, brighter-light producing LEDs are also possible. Generally, the control unit is designed so that a plurality of the lights may all be wired and/or connected to a single control unit.

The lights in the present system generally extend through the walls, floors, and/or ceilings such that they protrude into a portion of the room. This protrusion allows the light to illuminate the room in the event of an emergency. The lights are attached to one end of a wire via a “quick connector.” Likewise, the other end of the wire is also attached to the control unit via a similar quick connector. The use of such quick connectors means that the installation of the present lighting system is very easy and efficient and, because it involves low-voltage, may be done by the average homeowner instead of an expensive professional.

The control unit of the present system may also have a controller that is configured to selectively turn the lights on and off. The control unit and/or the controller is further configured to detect if the power to the building is lost and/or if there is another type of emergency. In such a situation, the controller will selectively turn the lights on to illuminate the desired area(s). In this manner, the present system functions as an emergency lighting system.

The present system may also be electrically connected (wired) to the building's smoke detector and alarm. Accordingly, if the smoke alarm is activated, the system will turn on one or more of the lights in the lighting system to provide light to the occupants who are trying to exit the building and/or deal with the fire in the building. In some embodiments, all of the lights in the building will be activated when the smoke alarm is activated in order to provide the greatest light to the building occupants. Generally, these lights in the system can be installed in the floor, along the exit routes, over and/or near the doors/windows, in the ceiling, in the wall, to provide emergency illumination to the occupants. Likewise, the present system may also be attached to a light sensor that will detect darkness.

The control unit of the present system also may include a timer. The timer is in electronic communication with the controller and is designed such that the user may set the system so that individual lights within the system will turn on and off at specified times. Using this ability to selectively turn on individual lights, the user can set the system so that certain lights will turn on during the nighttime hours. These lights that come on during the night hours function as nightlights. Likewise, because the user can selectively control when specific lights turn on and off, the user can set the system as a security lighting system—i.e., a system in which certain lights turn off and on throughout the evening or night to give the impression that there is an occupant in the building. The present system may also be attached to a light sensor that will detect darkness.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic view of an exemplar planned area of a building that includes an embodiment of a lighting system according to the present invention installed therein;

FIG. 2 is an partially cutaway perspective view of an embodiment of a light and a low-voltage wire that may be used as part of the present invention;

FIGS. 3A-3D provide a perspective view of various exemplary quick connectors and receptors that may be incorporated into the lighting system of the present embodiments; and

FIG. 4 is an elevated side schematic view of an exemplary embodiment of control unit that may be used as part of the present invention.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

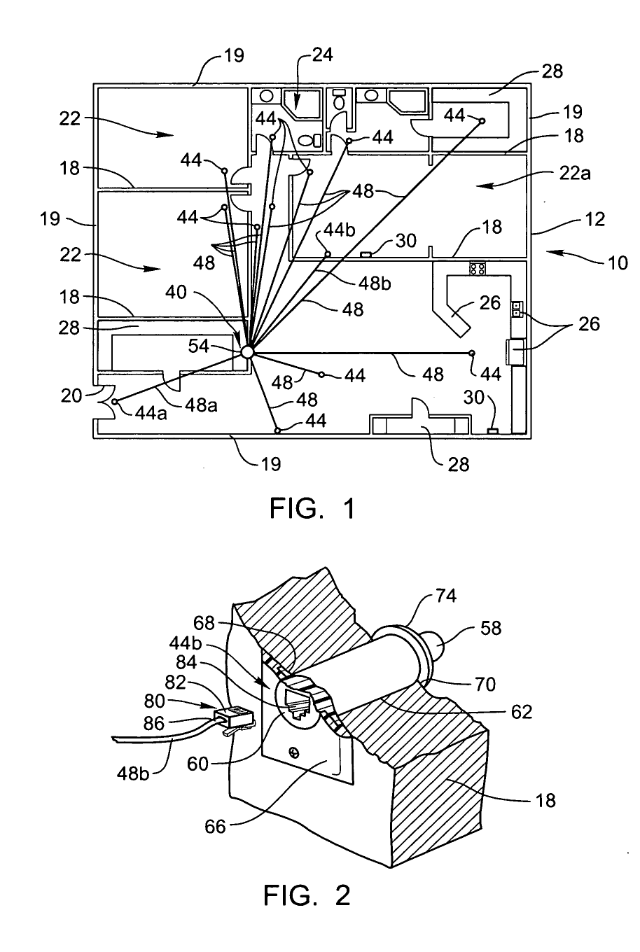

FIG. 1 is a schematic view of an exemplar planned area 10 of a building 12. In this Figure, the building 12 comprises a house/residence/office and the specific planned area 10 comprises the first floor of this area. Accordingly, the planned area 10 includes various features that are common to the first floor of a house/office including interior walls 18, exterior walls 19, a front door 20, rooms 22 (including bedroom 22a), bathrooms 24, furniture/appliance 26, closets 28, and/or one or more detectors 30 (which may be smoke detectors, carbon monoxide detectors, light sensors, etc.). Other features/elements that are common to houses/residences may also be included within the planned area 10.

Those of skill in the art will also recognize that, although FIG. 1 shows the building 12 as a house or office, other types of buildings may also be used. Specifically, in other embodiments, the building may comprise an office building, an apartment building, a multi-story building, a condominium, a store, a commercial building, a warehouse, a factory, a mall, or any other type of building that may be used for residential or commercial use. Likewise, although FIG. 1 shows the planned area 10 as being the first floor of the building, other embodiments may also be made in which the planned area 10 comprise office space, one floor of a multi-story building, a basement, etc. Still further embodiments may be constructed in which the planned area 10 comprises only a section or portion of a building floor, a few rooms in a building, etc. Yet further embodiments may be constructed in which the planned area 10 is a classroom or school (and is designed such that lights may be positioned at or near one or more of the pupil's desks).

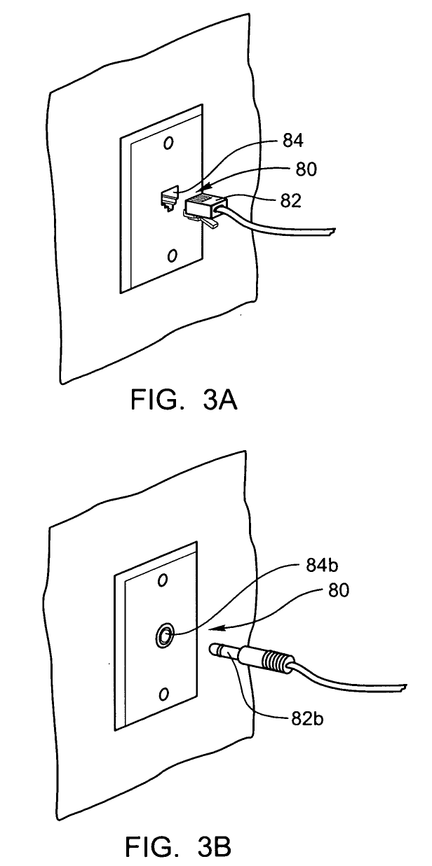

In FIG. 1, the planned area 10 of the building includes an embodiment of a lighting system 40 according to the present invention installed therein. The lighting system 40 includes at least one light 44. As shown in FIG. 1, the lights 44 are represented graphically as small “circles.” However, a more detailed depiction of these lights 44 will be shown and described below in conjunction with FIG. 2.

As shown in FIG. 1, usually a plurality of lights 44 will be included within the system 40 and will be installed throughout the planned area 10. For example, as shown in FIG. 1, light 44a is positioned proximate the front door 20 whereas light 44b is installed within the bedroom 22a. Of course, other embodiments may further be constructed such that one or more of the lights 44 are positioned proximate exits, gathering areas, staircases, first aid stations, bathrooms, offices, areas that must maintain 24-hour lighting, or other positions within the planned area 10 pursuant to the appropriate building safety codes and/or the desires of the building's tenant/owner.

In general, the lights 44 may be mounted on the walls, in or near the floor, and/or in the ceiling of the planned area 10 so that the light 44 will provide illumination to the area proximate the light 44. Thus, as shown in FIG. 1, the light 44b has been positioned on the wall 18 whereas light 44a has been positioned in the ceiling of the planned area 10. The exact way in which these lights 44 are positioned on or in the walls/ceiling/floor will be discussed below in conjunction with FIG. 2. However, further embodiments may also be made in which the lights 44 are otherwise positioned within the planned area 10 such as, for example, having the lights 44 be attached to the smoke detectors 30, having the lights 44 be attached to the existing lighting fixtures within the planned area 10, etc.

The lighting system 40 also includes at least one low-voltage wire 48. However, as shown in FIG. 1, most embodiments include a plurality of low-voltage wires 48. These low-voltage wires 48 are well known in the art.

As shown in FIG. 1, the wires 48 may be connected to the lights 44. This connection between the wires 48 and the lights 44 is generally accomplished through a “quick connector” and will be described and explained in greater detail below. In the embodiment shown in FIG. 1, each one of the wires 48 may be attached to a separate light 44. For example, the wire 48a attaches to the light 44a whereas the wire 48b attaches to the light 44b, etc. In other embodiments, more than one of the lights 44 will attach to a single wire 48 in the system 40.

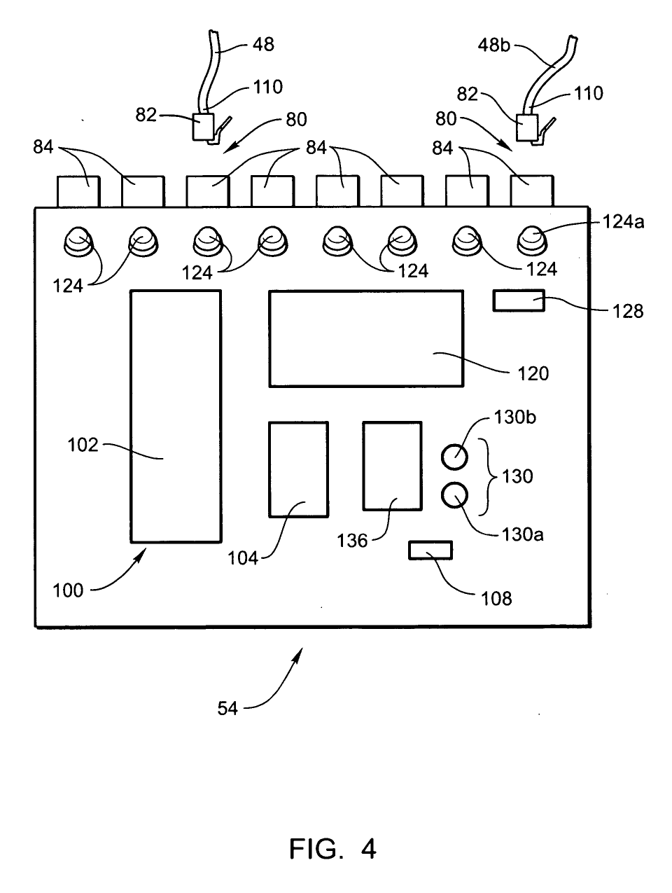

The lighting system 40 of the present invention also includes a control unit 54 (which is sometimes referred to as a “control box”). As shown in FIG. 1, the control unit 54 is represented graphically as a larger circle. However, a more complete depiction and description of this unit will be given below in conjunction with FIG. 4.

As can be seen in FIG. 1, the ends of all of the wires 48 are attached to the control unit 54. As with the connection between the lights 44 and the wires 48, the connection between the wires 48 and the control unit 54 may be made through a quick connector, which will again be described in greater detail below. The fact that all of the wires 48 terminate into one control unit 54 may provide an advantage over other previously known systems in that this configuration allows the system 40 to be an integrated system in which the user can configure the all of the lights 44 from one centralized location.

In the embodiment shown in FIG. 1, the control unit 54 is positioned within a closet 28 of the planned area 10. Such positioning of the control unit 54 within the closet 28 is generally desirable in that it is “out of the way” and will not detract from the decor of the planned area 10. Of course, the user may position the control unit 54 at other locations, such as by a breaker box, in the attic, in a furnace room, in the basement, outside of the planned area 10, etc.

As will be described in greater detail below, the control unit 54 is configured such that it may turn on or off the lights 44 within the system 40. More importantly, the control unit 54 is designed such that it may selectively turn on/off the lights 44 in the system 40. For example, embodiments may be constructed in which the control unit 54 may turn on lights 44b but leave the other lights 44 in the system 40 in the off position. Likewise, the control unit 54 may further be designed such that it will cause individual lights 44 in the system 40 to turn on or off at specified times of the day or when there is sufficient darkness to warrant nightlights.

Those of skill in the art will recognize that although the control unit 54 may be configured to turn on or off individual, specific lights 44, other embodiments may be constructed in which the lights 44 are grouped together as “zones.” In these embodiments, the control unit 54 may be designed to selectively control/turn on or off a zone of lights. For example, embodiments may be constructed in which all of the lights in the rooms 22, 22a may grouped together as “zone 1” whereas the lights 44 that are in the bathrooms 24 are grouped as a “zone 2,” etc. In these embodiments, the control unit 54 may operate to selectively turn on/off the lights in a specific zone—i.e., to control the lights 44 such that the lights 44 in zone 1 will turn on but the lights 44 in zone 2 will remain in the off position, etc.

FIG. 2, is a perspective view that shows, in greater detail, an embodiment of a light 44 that may be used in the present invention. Specifically, FIG. 2 shows the light 44b and the way in which the light 44b may be installed within the wall 18. Those of skill in the art will recognize that similar mounting techniques/methods may be used to position the lights 44 in the ceiling, in the floor, etc. Likewise, those of skill in the art will recognize that the elements of the light 44b shown in FIG. 2 may also be used to comprise the other lights 44, 44a in the system 40.

As shown in FIG. 2, the light 44b comprises an LED (light emitting diode) 58. Of course, other types of light or light sources may also be used. The LED 58 is a low-voltage lighting device that is commonly known and used in the industry. In general, the light 44b is configured such that the LED 58 is positioned on the interior of the wall 18 such that it is capable of providing illumination to the planned area 10 (shown in FIG. 1). Of course, in a similar manner, embodiments may also be constructed in which the light 44b is positioned on or proximate the ceiling of the planned area 10 or is positioned on or proximate the floor of the planned area 10 (shown in FIG. 1).

The light 44b may also comprise a base 60 that extends through an opening 62 in the wall 18. The LED 58 is attached to the end of the base 60. This base 60 may be made of plastic, metal, or other similar materials. Of course, the base 60 will also include various wires and/or other electrical components (not shown) that are capable of transmitting sufficient power to allow the LED 58 to illuminate the planned area 10.

One or more extensions 66 may also be added to the base 60. These extensions 60 are prongs or other similar features that are designed to contact/engage a portion of the wall 18 and prevent the base 60 and/or the light 44b from being pulled out of the wall 18. As shown in the FIG. 2, the extensions 60 engage the rear surface 68 of the wall 18. Other embodiments may also be constructed in which the extensions 60 engage other portions of the wall 18, such as the front surface and/or the middle of the wall 18. Although the base 60 in FIG. 2 passes through the wall 18, it should be understood that the base 60 could also be entirely concealed within the wall 18 so that only the LED 58 protrudes through the wall 18 or is visible when looking at that location on the wall 18.

In additional embodiments, the light 44b may comprise a decorative washer 74 that is positioned along the interior surface 70 of the wall 18. The decorative washer 74 is designed such that it surrounds the LED 58. The washer 74 may help to secure/hold the light 44b in the proper position. Additionally, the decorative washer 74 may be designed to make the light 44b more decorative and visually appealing. Further embodiments may be constructed in which the decorative washer 74 helps to dissipate the heat that is generated by the light-fixture.

As noted above, the light 44b may be attached to the low-voltage wire 48b. In general, this connection between the light 44b and the wire 48b will be accomplished through a “quick connector” 80. As used herein, the term “quick connector” refers to a jackplug or any other type of device that connects two devices together by simply having an extension (i.e., a “jack”) be inserted into a receptor (i.e., a “plug”). Typical examples of “quick connectors” include phone jacks, stereo headphone mini-plugs, RCA stereo jacks, RJ-45 connectors (such as the type used for computer networks), RJ-11 connectors, USB ports (and that associated jackplug that fits into a USB port), the jackplug used with DVD cables (and that associated receptor), the jackplugs currently used on cabling for between a printer and a computer (and the associated receptor), etc. The jackplugs associated with coaxial cables, or Toslink cables may also be used.

As shown in FIG. 2, the quick connector 80 that connects the light 44b to the wire 48b is a low-voltage quick connector 82 and a receptor 84. This low-voltage quick connector 82 is similar to a phone jack. As is known in the art, the receptor 84 is designed so that the low-voltage quick connector 82 may be inserted into the receptor 84. As shown in FIG. 2, the low-voltage quick connector 82 is attached to a first end 86 of the wire 44b and the receptor 84 is attached to the base 60. In other embodiments, the receptor 84 may be a portion of the base 60 such that the phone jack 82 plugs directly into a portion of the base 60. Still further embodiments may be constructed in which the low-voltage quick connector 82 is added to the base 60 and the receptor 84 is added to the wire 48b.

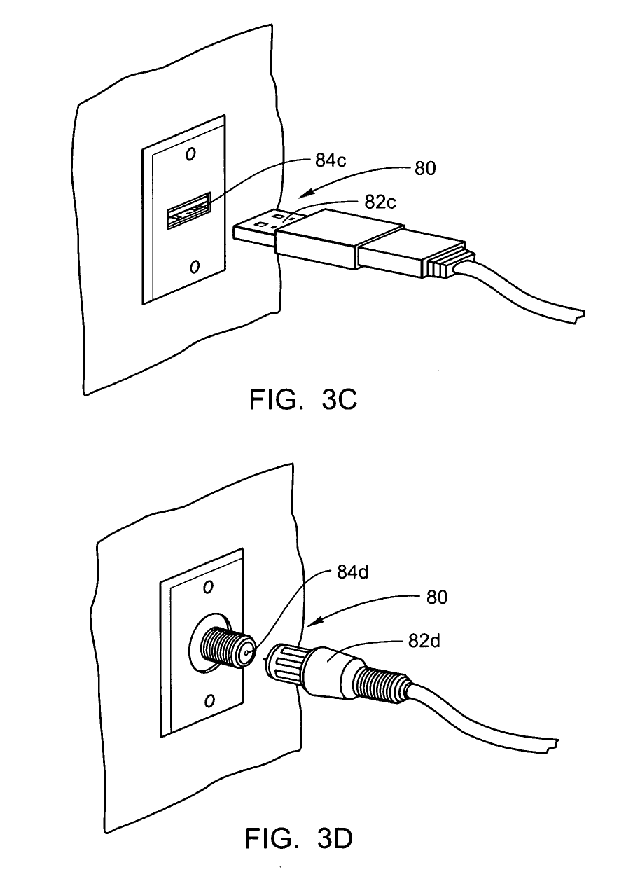

Referring now to FIGS. 3A-3D, various drawings of typical quick connectors 80 and the associated receptor 84 are illustrated. For example, FIG. 3A shows the embodiment in which the quick connector 82 comprises a low-voltage quick connector 82 (that is similar to a phone jack) as well as the associated receptor 84. FIG. 3B shows the embodiment in which the quick connector 80 comprises a stereo headphones jackplug 82b as well as the associated receptor 84b. FIG. 3C shows the embodiment in which the quick connector 80 comprises a USB port jack 82c with the associated receptor 84c. FIG. 3D shows the embodiment in which the quick connector 80 comprises a DVD cable jack 82d with the associated receptor 84d. These types of quick connectors 80 and receptors 84 are known in the art. However, the representations of FIGS. 3A-3D clearly demonstrate how the quick connector 82 may fit into the receptor 84 and provide the appropriate electrical connection between the device and the wire. Those of skill in the art will readily appreciate how these quick connectors 80 and receptors 84 may be added to the wires 48 and lights 44/control unit 54 to provide the desired quick and easy connection method.

Referring now to FIG. 4, a side elevation schematic view of a control unit 54 that may be used in the present system 40 (see FIG. 1) is illustrated in greater detail. As shown in FIG. 4, the control unit 54 may comprise a power source 100. The power source 100 is designed such that it is capable of supplying power/electricity to both the control unit 54 and the lights 44 (not shown in FIG. 4). In general, the power source 100 comprises a battery 102 and a battery recharger 104. Various types and sizes of batteries and battery rechargers are known in the art and may be used in accordance with present invention. In general, the battery recharger 104 is designed such that it will recharge the battery 102 using power/electricity obtained by directly connecting the wire (not shown) to the electrical system of the planned area 10. A power detector 108 that determines whether power is being supplied to the control unit 54 may be added. Further embodiments may be constructed in which the control unit 54 will include a plug that may be plugged into an electrical outlet to provide power to the recharger 104 of the control unit 54.

As noted above, the wires 48 may be connected to the control unit 54. In general, this may be accomplished by having a second end 110 of the wire 48 attach to the control unit 54 via a quick connector 80. Again, the quick connector 80 that is shown in FIG. 4 comprises a low voltage quick connector 82 that is positioned on the wire's second end 110 and a receptor 84 that is added to the control unit 54 by way of example. Of course, other embodiments may be constructed in which the low voltage quick connector 82 is added to the control unit 54 and the receptor 84 is added to the second end 110 of the wire 48.

As can be seen in FIG. 4, multiple receptors 84 are generally positioned on the control unit 54. These multiple receptors 84 allow all of the wires 84 to be connected to and controlled by the control unit 54. In FIG. 4, eight (8) specific receptors 84 have been added to the control unit 54. Other embodiments may, depending on the size of the system 40 and the size of the planned area 10, may include another number of receptors 84 such as, for example, 4 receptors, 12 receptors, 16 receptors, 20 receptors, etc.

The control unit 54 will also include a controller 120. As used herein, a “controller” is any device that includes a digital processor capable of receiving and processing data or information. In one embodiment, the controller 120 is a microcontroller. In other embodiments, the controller 120 will be a PLC (“Programamble Logic Controller”). Further embodiments may also be constructed in which the controller includes a computer, a hand-held computer, a personal computer, a server, a mainframe, a supercomputer, and/or combinations thereof. As will be explained in greater detail below, the controller 120 is designed to selectively control the lights 44 such that individual lights 44 turn on or off in accordance with the user's desires and specifications.

The control unit 54 will additionally include a timer 124. More than one timer 124 may also be used. The timers 124 may be any device or equipment, whether digital or analog, that is capable of keeping time. In some of the presently preferred embodiments, the exact number of timers 124 found on the control unit 54 will be the same as the number of receptors 84.

Each specific timer 124 is designed to correspond to a particular light 44 within the system 40. As will be described in greater detail below, the timers 124 are in electronic communication with the controller 120 and is designed such that if a user enters specific times into one of the timers (such as timer 124a), the controller 120 will cause the light associated with timer 124a to turn on or off in accordance with the times selected by the user. One or more display units 128 may also be added to display the times entered into the control unit 54 and/or to otherwise facilitate the user in entering specific times into the control unit 54.

The control unit 54 may additionally comprise one or more indicator lights 130 that tell the user the status of the control unit 54 and/or the lighting system 40. For example, one of the indictor lights 130 may be a “low battery” light 130a that indicates when the power source 100 is low on power. If the user sees this light turn on, he or she will know that the control unit 54 needs to be recharged. Likewise, the indicator light 130 may be an “all systems go” light 130b which indicates to the user that the control unit 54 and/or the lighting system 40 is functioning properly. Those of skill in the art will recognize that other types of indicator lights 130 also may be used.

Referring still to FIG. 4, the control unit 54 may additionally comprise a receiver 136 that is capable of receiving signals from detectors 30 (which as noted above may be smoke detectors, carbon monoxide detectors, light sensors, etc.). In some embodiments, the receiver 136 is an RF (radio frequency) receiver that detects and receives signals sent out by the detectors 30. These signals received from the detectors 30 will indicate to the control unit 54 that an emergency (such as a fire, etc.) is occurring within the planned area 10. Of course, in other embodiments, the control unit 54 may be designed to communicate with the detector 30 via other means, such as through wireless or wired communication technologies.

Referring now to FIGS. 1-4 generally, the operation of the lighting system 40 will be described in greater detail. The fact that the lights 44 are installed throughout the planned area 10 means that the present lighting system 40 can function as an emergency lighting system. Specifically, if power/electricity is lost to the planned area 10, this power outage will be detected by the power detector 108. The power detector 108 will alert the controller 54 that power has been lost. In turn, the controller 54 will then cause one or more of the lights 44 to turn on and illuminate the planned area 10. Generally, during an emergency or power outage, the system 40 will cause all the lights 44 to turn on. However, other embodiments may be constructed such that only some of the lights 44 turn on during a power outage or an emergency. Power for these lights 44 will be provided by the power source 100, which is configured to have power sufficient for the lights 44 to remain on for at least two (2) hours or until power is restored.

Likewise, if the receiver 136 receives a signal from the smoke detector 30 that the building 12 is on fire or is experiencing smoke, the control unit 54 will cause one or more of the lights 44 to turn on, thereby aiding the occupants to more easily exit the building 12. In a similar manner, the control unit 54 may cause one or more of the lights 44 to turn on if the receiver 136 receives a signal from a carbon monoxide detector 30 indicating that the building 12 is filled with harmful carbon monoxide gas. Usually, if such signals are received from the detector(s) 30, the control unit 54 will cause all of the lights 44 in the planned area 10 to turn on, thereby providing the greatest amount of light to the occupants attempting to exit the building 12. Thus, in this manner, the present lighting system 40 provides an emergency lighting that operates to increase the safety of the planned area 10/building 12.

However, unlike other previously known lighting systems, the present lighting system 40 may also be used as a night lighting system or as a security lighting system. For example, as noted above, the present lighting system 40 includes multiple timers 124 that are specific to each of the lights 44 in the system 40. The system 40 is designed such that using the timer 124, the user can selectively program the control unit 54 so that specific lights 44 within the system 40 will turn on and off at desired times. If the user programs the system 40 so that the lights 44 come on at night hours and then turn off during the daytime hours, the system 40 will effectively function as a night light system.

For example, the user may program the timer 124a such that the light that is associated with this timer will turn on at an evening hour (such as 9:00 PM) and then will turn off at a morning hour (such as 7:00 AM). Using this information, the controller 120 will selectively cause the light 44b, which is associated with the timer 124a via the wire 48b, to turn off and on at these specified nighttime and daytime hours. By having the light 44b come on during these nighttime hours, the light 44b effectively functions as a nightlight and will provide the low-level lighting appropriate for a nightlight system. Of course, other lights 44 may similarly be programmed to provide the desired nightlights for bathrooms, hallways, etc. In this manner, the present lighting system 40 allows the user the ability to program his or her system 40 so that system 40 functions as a nightlight system and the user does not have to incur the additional expense of purchasing external nightlight units.

Similarly, the timers 124 and the controller 120 also allow the present system 40 to function as a security lighting system. Using the control unit 54, the user can program his or her system 40 so that various lights 44 will turn on and off at specified times. For example, the user can program the system 40 so that at 2:00 AM the lights 44 in the bedroom 22a will turn on and remain on for one hour, and then, at 3:00 AM, the lights 44 in the rooms 22 will turn on and remain for one hour, etc. By selectively turning on and off the lights 44 within the planned area 10, these lights 44 will give the impression to a would-be perpetrator/thief that someone is present in the planned area 10 and thus, the system 40 may effectively function as a security lighting system.

As explained herein, the control box 54 may be used to control a variety of different lights or light fixtures that are disposed throughout a planned area 10. These lights may be the light/light fixtures outlined herein, or may be the lights/light fixtures disclosed U.S. patent application Ser. No. 11/435,945 (the “'945 application”) or U.S. patent application Ser. No. 10/733,853 (“the '853 application”). (As noted above, both the '945 application and the '853 application are incorporated herein by reference). With respect to the lights/light fixtures of the '945 application and the '853 application, these lights/light fixtures may be modified such that the circuit board/controller is not positioned on the light itself; rather, as explained herein, the circuit board and/or controller is part of the control box 54. Thus, the control box 54 will control all of the lights/light fixtures in the planned area 10 and will determine when such lights should turn on or off.

Further embodiments may also be made in which the lights/light fixtures taught by the '945 application and the '853 application are modified such that one or more of the fluorescent lights are replaced with LEDs. In some embodiments, the only light-producing device will be LEDs that are controlled by the control box 54. Of course, in order to ensure that the LEDs will provide sufficient light (for both emergency/low-light situations and normal use), either LEDs with a greater intensity (brightness) may be used and/or the number of LEDs used in the light fixture may be increased.

In the embodiments in which the control box 54 controls multiple lights throughout the planned area 10, the presently preferred embodiments are designed such that the lights will be electrically connected to the control box 54 via wiring that uses quick connectors. Other embodiments may also be constructed in which regular wires and/or wiring are used that do not include the quick connectors.

It is readily apparent that the present embodiments also provide a method for providing emergency and security lighting to a planned area. Specifically, all this method entails is obtaining a system 40 and then installing this system into the planned area 40. As outlined above, once the system 40 has been installed, one or more of the lights 44 will be turned on/off by the controller in the event of an emergency, at night, or at a specified times during the day.

In sum, the present embodiments provide a lighting system that may be used for emergency lighting, night-lighting, security lighting, etc. Quick connectors are used in the present embodiments so that this system may be readily and easily installed in a building.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A lighting system comprising:
a plurality of low-voltage lights that are capable of being installed in a planned area;
a plurality of low-voltage wires, wherein each one of the wires is attached to a separate light via a quick connector; and
a control unit that is attached to each wire via a quick connector, wherein the control unit comprises:
a power source that is capable of providing power to each light; and
a controller, wherein the controller is capable of causing each of the lights to turn on or off.

2. A lighting system as in claim 1 wherein each light comprises a base and a light emitting diode.

3. A lighting system as in claim 1 wherein the quick connectors comprise a low-voltage quick connector and a receptor capable of receiving the low-voltage quick connector.

4. A lighting system as in claim 1 wherein the controller is configured to turn the lights on if the planned area loses power.

5. A lighting system as in claim 1 wherein the system comprises a timer and the timer selectively causes the at least one light to turn on and off at specific times during the day.

6. A lighting system as in claim 1 wherein the power source comprises a battery and a battery recharger.

7. A lighting system as in claim 1 wherein the controller causes the lights to turn off or on based upon signals received from a detector.

8. A lighting system as in claim 1 wherein the control unit further comprises one or more indicator lights.

9. A lighting system as in claim 1 wherein the controller is capable of selectively causing individual lights within the system to turn off or on.

10. A lighting system comprising:
a light comprising a LED, wherein the light is capable of being installed in a planned area;
a low-voltage wire comprising a first end and a second end, the first end of the wire being attached to the light; and
a control unit attached to the second end of the wire, the control unit comprising:
a battery and a battery recharger capable of recharging the battery, wherein the battery provides power to the control unit, the battery is further configured such that it is capable of providing power to each light; and
a controller capable of causing the light to turn on or off;

11. A lighting system as in claim 10 further comprising a first quick connector and a second quick connector, the first quick connector attaching the first end of the wire to the light and the second quick connector attaching the second end of the wire to the control unit, wherein both the first quick connector and the second quick connector each comprise a receptor.

12. A lighting system as in claim 10 further comprising a timer for the user to enter a first time and a second time into the timer, wherein the control unit turns on at least one light at the first time and turns off the at least one light at the second time.

13. A lighting system as in claim 10 wherein the control unit further comprises a power detector that determines whether power is being supplied to the control unit.

14. A lighting system as in claim 10 wherein the control unit further comprises a receiver that receives signals from a detector disposed in the planned area;

15. A method for providing emergency and security lighting to a planned area in a building, the method comprising:
installing a lighting system comprising a plurality of low voltage lights that are capable of being installed in a planned area, a plurality of low-voltage wires, wherein each one of the wires is attached to a separate light via a quick connector; and a control unit that is remote from the lights and is attached to each wire via a quick connector, wherein the control unit comprises a timer, a power source that is capable of providing power to each light, and a controller, wherein the controller is capable of causing each of the lights to turn on or off; and
configuring the system such that one or more the lights will turn on based upon commands from the controller.

16. A method as in claim 15 wherein the controller turns on the lights based upon a signal received from a detector, the signal indicating an emergency situation.

17. A method as in claim 15 wherein the controller turns on one or more of the lights in the event that power is lost to the planned area.

18. A method as in claim 15 wherein the controller selectively causes individual lights within the system to turn off or on at specified times during the day.
